(19) United States
(12) Patent Application Publication
(10) Pub. No.: US 2015/0305976 A1
(43) Pub. Date: Oct. 29, 2015

(54) Dry Sauna Machine

(71) Applicants: Seung Woo Lee, Yorba Linda, CA (US); Sang Won Lee, Yorba Linda, CA (US); Calvin Logan Ross, Irvine, CA (US)

(72) Inventors: Seung Woo Lee, Yorba Linda, CA (US); Sang Won Lee, Yorba Linda, CA (US); Calvin Logan Ross, Irvine, CA (US)

(21) Appl. No.: 14/259,573

(22) Filed: Apr. 23, 2014

(51) Int. Cl. A61H 33/06

(52) U.S. Cl. CPC A61H 33/063; A61H 2033/061; A61H 2201/0228; A61H 2201/0188

(57) ABSTRACT

A dry sauna machine is provided, which adjusts temperature according to user's taste and adjust angle of heater according to user's sitting position. The machine includes a main body (10) for receiving a partial or whole body of the user, a heater (20) installed on floor surface of the main body (10), a far-infrared radiating member (30) installed on a top surface of the heater (20), and a foot stand (40) installed on both sides with respect to the heater (20) in order to avoid heat from the heater (20). And the far-infrared radiating member (30) has a groove on the top thereof for aroma oil.

### RELATED APPLICATION

This application is a continuation-in-part of U.S. patent application Ser. No. 14/175,948 for “A Dry Sauna Machine” filed on Feb. 7, 2014.

### FIELD OF TECHNOLOGY

The present invention relates to a dry sauna machine.

### BACKGROUND OF THE INVENTION

In general, a sauna is for a hot bath by using steam or hot and dry heat, facilitating blood circulation and exuding of bodily waste such as sweat so as to facilitate the metabolism, which has been used widely all around the world.

The sauna may be categorized to dry-type sauna and wet-type sauna, and by their sizes they can be divided to saunas for feet, knee, half-body, and whole body and can be installed at home or public sauna businesses.

Recently, as the interest about health goes up, a dry-type sauna gets more and more popularity, which can be used conveniently at home and avoid humidity indoors.

Usually, a surface-type heating body in which a surface emits heat evenly across it has been applied in the dry-type sauna, and this surface-type heating body has been used intensively due to its high safety, saving of space, and heat-emitting effects.

The conventional sauna technologies had been disclosed in Korean Patents 20-0386051, 20-0376748, and 20-0363512, Korean Patent Application Publications 10-2003-0065378, and Korean Patents 20-0188475 and 20-0186494.

On the other hand, in the sauna businesses, sauna, and home, it has been usual to apply material such as salt, charcoal, red clay, germanium, elvan, jade, etc. and make an environment facilitating absorption of far-infrared radiation, negative ion, constant temperature and humidity, etc. emitted from the above material into the body, and the properties of such materials had been disclosed in detail in Korean Patent 10-0528650.

However, in the case of conventional saunas in the above, as wood boards evenly installed over the top of the surface-type heating body form a foot stand and the heat comes out from the gaps in the foot stand, it could not heat the feet evenly, thus the raised temperature caused waste of electrical power, and in case of overheating of feet, the feet had to be raised up for a while because there is no place to put the feet on avoiding the heat inside and then lowered to use the sauna again afterward, which was a problem of dire inconvenience.

### SUMMARY OF THE INVENTION

### Problems to Solve

The present invention contrives to solve the disadvantages of the prior art, and the object of the invention is to provide a dry sauna machine, in which the usage is very convenient, the temperature can be chosen according to the user's taste, and the angle of heater can be adjusted according to how the user sits.

### Solutions to Problems

A sauna according to the invention comprises:

a main body configured to receive a partial or whole body of a user;

a heater installed on a floor surface of the main body;

a far-infrared radiating member installed on a top surface of the heater;

a foot stand installed at a side inner surface of the main body.

The far-infrared radiating member comprises a groove adapted for containing aroma oil. And, the groove in the far-infrared radiating member is half-circular.

Also, in the invention, the heater extends up to a lower surface of the foot stand.

Also, in the invention, the heater is a surface-type heating body.

Also, in the invention, the far-infrared radiating member is one of planar type, spherical type, and egg type.

Also, in the invention, the far-infrared radiating member is made of one selected from the group consisting of tourmaline, red clay, rock salt, germanium, elvan, jade, charcoal, and ceramic.

Also, in the invention, the sauna further comprises an insulator provided between the floor surface of the main body and the heater.

Also, in the invention, the heater is installed so as to stay away from the floor surface of the main body rotatable about an axle.

Also, in the invention, the dry sauna machine may further comprise a plurality of light-emitting diodes (LEDs) disposed along one or two edges of the far-infrared radiating member and configured to illuminate the far-infrared radiating member from edges thereof.

The plurality of light-emitting diodes (LEDs) may be disposed in an assembling frame.

### Effects of Invention

According to the invention, with the feet on the far-infrared radiating member, when the feet get hot due to heat from the heater and the far-infrared radiating member heated by the heater, the user can move the feet on the foot stand swiftly and conveniently so as not to have to lift the feet repeatedly whenever the feet get hot as in conventional sauna, getting rid of the problems that the user avoided the usage of the sauna for the inconvenience.

Also, since the feet touch the far-infrared radiating member directly the user can feel the heat fast, and since the sauna can be used conveniently by those who like hot temperature and lukewarm temperature it can be used widely and conveniently according to their tastes.

And, if rubbing the feet while touching the far-infrared radiating member of spherical or egg type directly, an effect of massaging can be expected since the soles of the feet are stimulated.

Furthermore, by installing the insulator between the floor surface of the main body and the heater, sagging or vibrating of the heater can be prevented, getting rid of the user's worrying of the it and keeping unnecessary heat from being transferred to the floor.

Still furthermore, by installing the heater rotatably about the axle, the user can adjust the angle of the heater according to how the user sit, and the user can touch the far-infrared radiating member installed at the heater easily.

### BRIEF DESCRIPTION OF THE DRAWINGS

These and other features, aspects and advantages of the present invention will become better understood with reference to the accompanying drawings, wherein:

FIG. 1 is a perspective view showing a dry sauna machine according to an embodiment of the invention;

FIG. 2 is a cross-sectional view along line A-A′ of FIG. 1;

FIG. 3 is an exploded view showing parts of a dry sauna machine according to another embodiment of the invention;

FIG. 4 is a cross-sectional view along line B-B′ of FIG. 3;

FIG. 5 is an exploded view showing parts of a dry sauna machine according to still another embodiment of the invention;

FIG. 6 is a cross-sectional view along line C-C′ of FIG. 5;

FIG. 7 is an exploded view showing parts of a dry sauna machine according to still another embodiment of the invention;

FIG. 8 is a cross-sectional view along line D-D′ of FIG. 7;

FIG. 9 is a cross-sectional view showing parts of a dry sauna machine with LEDs for illuminating far-infrared radiating member according to still another embodiment of the invention; and

FIG. 10 is a top perspective view of the dry sauna machine with LEDs of FIG. 9.

### DETAILED DESCRIPTION EMBODIMENTS OF THE INVENTION

Below, referring to the figures, a dry sauna machine for feet among sauna for feet, knee, half-body, and whole body is described in detail.

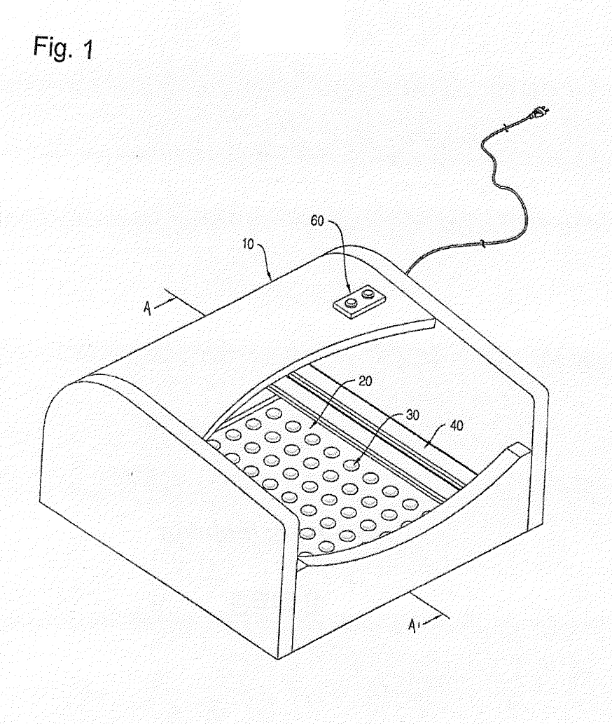

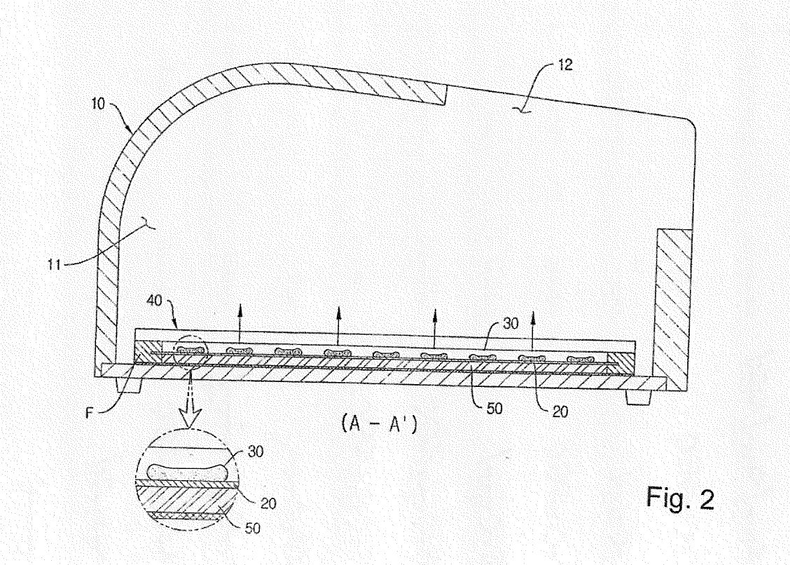

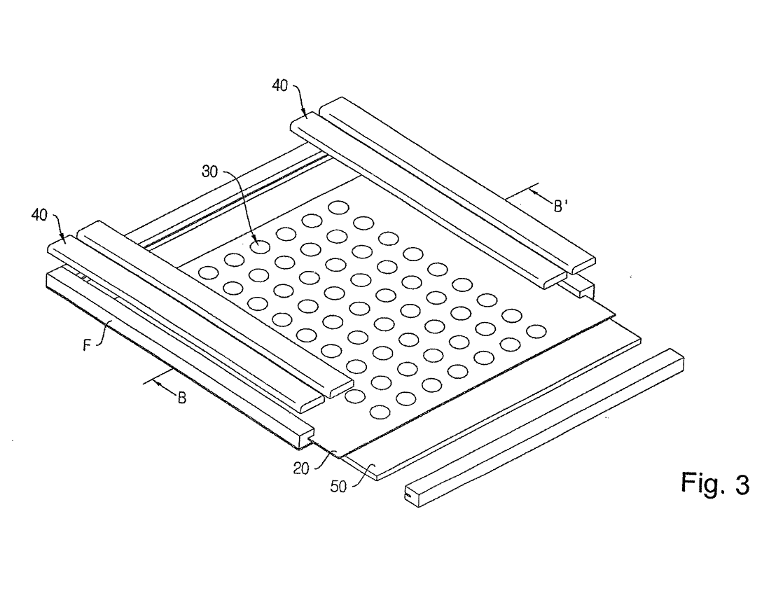

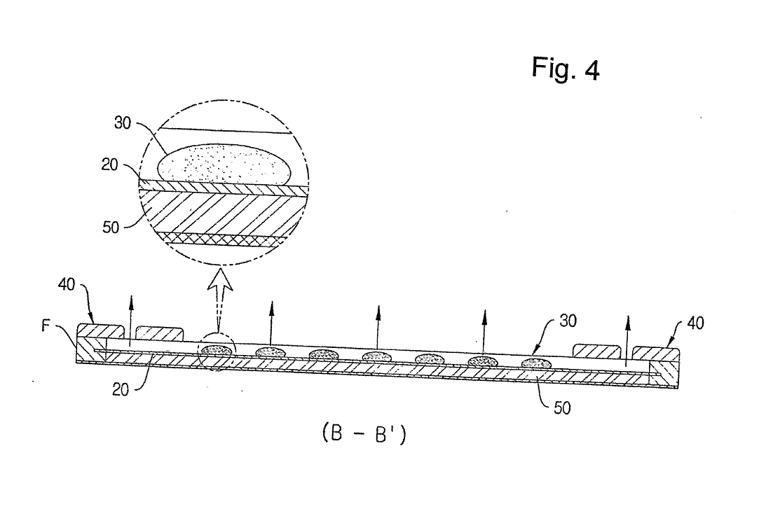

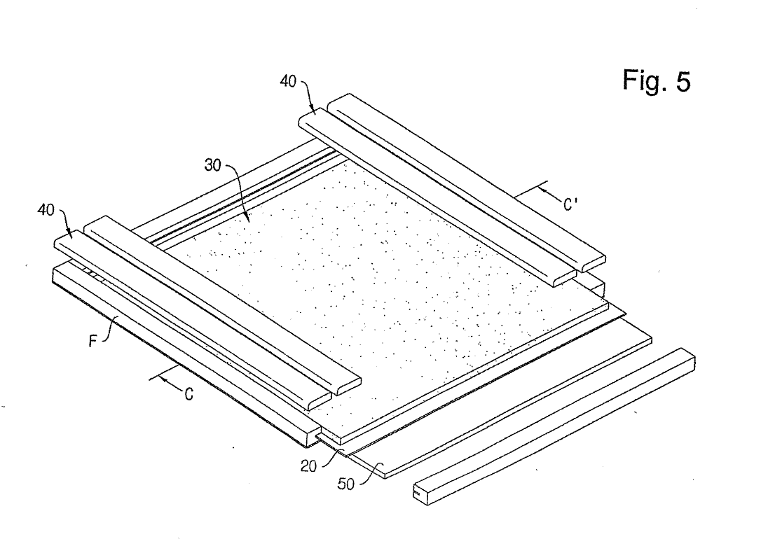

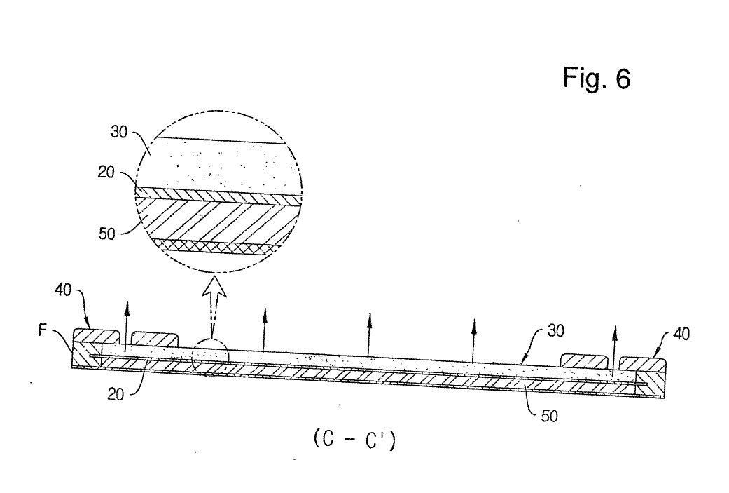

FIG. 1 is a perspective view showing a dry sauna machine according to an embodiment of the invention, FIG. 2 is a cross-sectional view along line A-A′ of FIG. 1, FIG. 3 is an exploded view showing parts of a dry sauna machine according to another embodiment of the invention, FIG. 4 is a cross-sectional view along line B-B′ of FIG. 3, FIG. 5 is an exploded view showing parts of a dry sauna machine according to still another embodiment of the invention, and FIG. 6 is a cross-sectional view along line C-C′ of FIG. 5.

Referring to FIGS. 1-4, a dry sauna machine according to an embodiment of the invention comprises a main body (10), a heater (20), a far-infrared radiating member (30), and a foot stand (40), and further comprises a insulator (50).

The far-infrared radiating member (30) comprises a groove adapted for containing aroma oil. And, the groove in the far-infrared radiating member is half-circular especially shown in FIGS. 1 and 2. Thereby, the user can have soles of the feet applied with the aroma oil put in the groove in advance.

Referring to FIGS. 1 and 2, the main body (10) comprises a receiving portion (11) for receiving the feet inside and an entrance (12) provided at one side.

The heater (20) is a surface-type heating body for having electrical power from outside and emitting heat, and in the embodiment as shown FIG. 3, it is inserted at a groove of an assembling frame (F) and installed on the floor surface of the main body (10) along with the frame (F).

And, the operation of the heater (20) is controlled by a controller (60, refer to FIG. 1) formed in the main body (10).

As an example, the heater (20) is shown and described to be installed on the floor surface of the main body (10), but that is just an example, and if necessary, the heater (20) can be installed inside the heater (20).

The far-infrared radiating member (30) may be made of one selected from the group consisting of tourmaline, red clay, rock salt, germanium, elvan, jade, charcoal, and ceramic.

The far-infrared radiating member (30) may be manufactured in a planar shape (FIGS. 5 and 6), spherical or egg shape (refer FIG. 3 and FIG. 4), and in various shapes that is well known in the community.

In the case of this embodiment, the far-infrared radiating member (30) is installed (fixed) on the top surface of the heater (20) through an attaching means.

Here, the attaching means includes anti-heat silicon glue or anti-heat double-sided tape, and if performing this function, any material well known to the community may be applied.

On the other hand, with respect to the heater (20), the foot stand (40) is installed on a side inner surface of the main body (10) for avoiding heat of the heater (20).

The foot stand (40) is formed on both sides of the frame (F).

According to the embodiment, with the feet on the far-infrared radiating member (30), when the feet get hot due to heat from the heater (20) and the far-infrared radiating member (30) heated by the heater (20), the user can move the feet on the foot stand (40) swiftly and conveniently so as not to have to lift the feet repeatedly whenever the feet get hot as in conventional sauna, getting rid of the problems that the user avoided the usage of the sauna for the inconvenience.

On the other hand, so as to make the heat from the heater (20) through the foot stand (40), the heater (20) is configured to extend up to the lower surface of the foot stand (40), which is shown in FIGS. 3 and 4.

According to the embodiment, when the feet get too hot while using the dry sauna, the feet can be moved over to the foot stand (40) for a rest, and even during the rest, the feet can receives lukewarm heat of the heater (20) through the 40.

Therefore, both those who like hot temperature and those who like lukewarm temperature can use it conveniently, making the usage thereof maximized and making the usage convenient and chosen easily according to the user's tastes.

On the other hand, when enjoying the dry sauna while putting the feet on the heater (20) where the far-infrared radiating member (30) is installed, since the heater (20) is inserted and fixed in the frame (F), there may be problems that the heater (20) is sagged or dislocated seriously due to the weight of the feet, and especially the heat of the heater (20) may be transferred to the floor of the main body (10) unnecessarily.

In order to solve the above problem, in the case the embodiment, the insulator (50) may be further provided between the floor surface of the main body (10) and the heater (20).

For the insulator (50), a material such as cork may be preferable, which is able to withstand the heat of the heater (20) and support the heater (20) against the weight of the feet.

According to the embodiment, by installing the insulator (50) between the floor surface of the main body (10) and the heater (20), the sagging and undulating of the heater (20) can be prevented, getting rid of the user's worrying and blocking the transferring of unnecessary heat into the floor.

On the other hand, the feet of the user maintains a state of tilting naturally while leaning against a sofa, and a horizontal state while sitting upright on the sofa. That is, the position of the feet changes with how the user sits on the sofa, and in a configuration shown in FIG. 2, since the user must use the dry sauna in an upright sitting position or must move the ankles forcibly so as to touch the feet against the far-infrared radiating member (30), the user cannot help but feel very uncomfortable, which may make the user avoid using the dry sauna or use less.

In order to solve the above problems, in the case of the embodiment, the heater (20) is formed rotatably inside the main body (10).

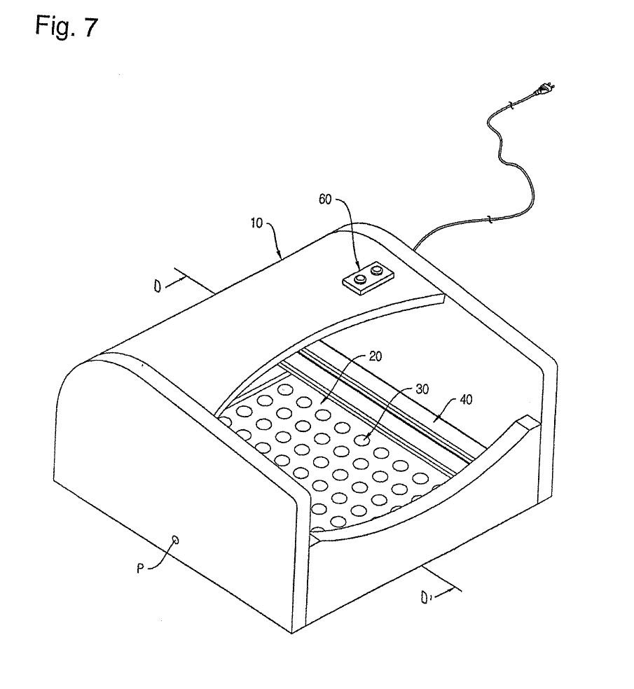

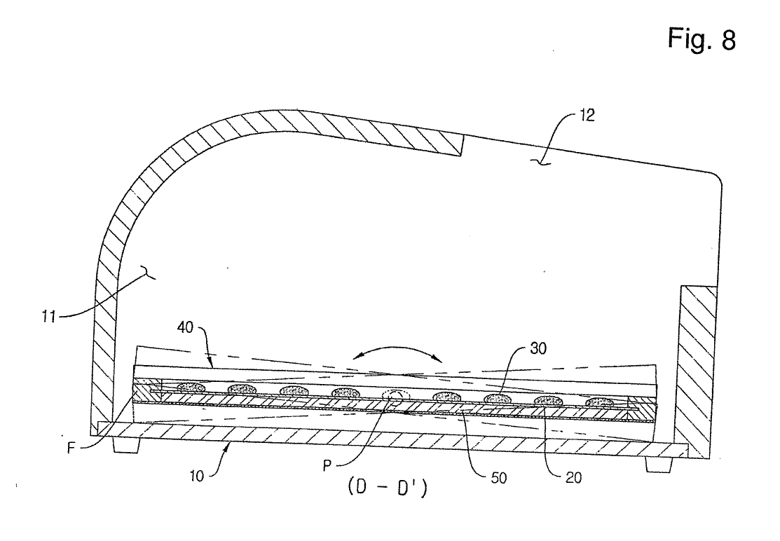

FIG. 7 is an exploded view showing parts of a dry sauna machine according to still another embodiment of the invention, and FIG. 8 is a cross-sectional view along line D-D′ of FIG. 7.

Referring to FIGS. 7 and 8, the heater (20) is provided away from the floor surface of the main body (10) and installed rotatably with respect to the axle (P).

As an example, the axle (P) is installed on both sides of the frame (F) fixing the heater (20), and fixed rotatably to the main body (10).

According to the embodiment, by installing the heater (20) rotatably to the main body (10) through the axle (P), the user can adjust the angle of the heater (20) conveniently according to the sitting position, as well as touch the feet closely against the far-infrared radiating member (30) installed in the heater (20).

The operation of the invention having the above structure is going to be described below.

First, the power cord (refer to FIG. 1) is connected to the plug.

Next, the user inserts the feet inside the main body (10) and puts them on a top surface of the far-infrared radiating member (30) installed in the heater (20).

And, by controlling the controller (60, refer to FIG. 1) installed in the main body (10), the temperature setting and the timer may be set.

If the feet feel too hot in the process of using the dry sauna as in the above, the feet can be moved over to the foot stand (40) formed on both sides of the heater (20).

Especially, even while taking a rest with the feet on the foot stand (40), some lukewarm heat from the heater (20) may be delivered to through the foot stand (40).

On the other hand, when leaning due to uncomfortable sitting position, if pressing down the heater (20) with heels, the heater (20) rotates with respect to the axle (P, refer to FIG. 8) and the soles get pushed against the far-infrared radiating member (30) installed in the heater (20), such that the user can keep enjoying the dry sauna.

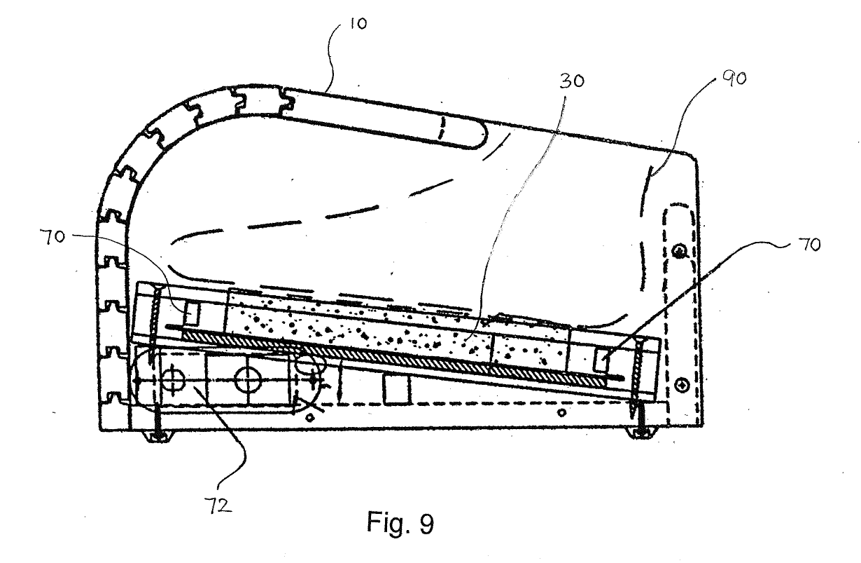

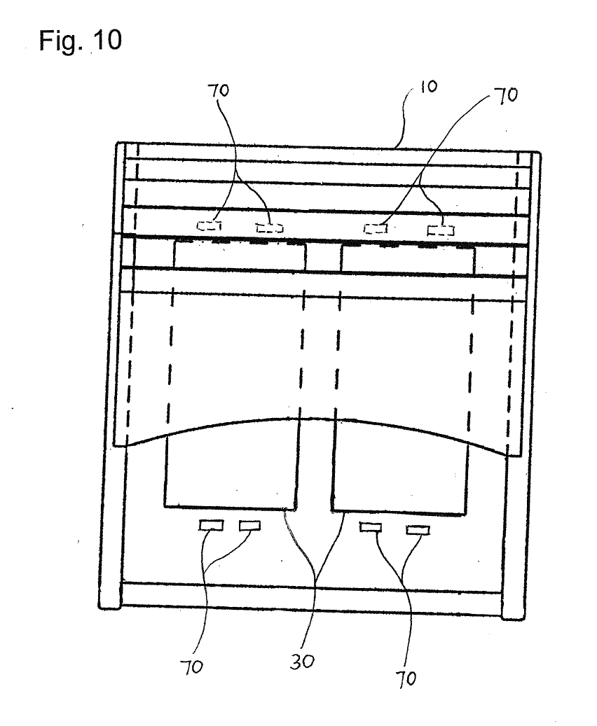

In certain embodiments, the dry sauna machine may further comprise LEDs for illuminating the far-infrared radiating member (30) as shown in FIGS. 9 and 10.

As shown in FIGS. 9 and 10, the dry sauna machine may further comprise a plurality of light-emitting diodes (LEDs) (70) disposed along one or two edges of the far-infrared radiating member (30) and they are configured to illuminate the far-infrared radiating member (30) from edges thereof.

The plurality of light-emitting diodes (LEDs) (70) may be disposed in an assembling frame (F).

In certain embodiments, the dry sauna machine may still further comprise as LED adapter (72) as shown in FIG. 9.

Due to the plurality of light-emitting diodes (LEDs) (70), the far-infrared radiating member (30) may shine with bright orange or amber light. And, if the far-infrared radiating member (30) includes two slaps as shown in FIG. 10, those bright amber light plates may be used to show the user where to step on with his/her foot (90), for example.

The invention has been described using the detailed embodiments, but it will be appreciated by those skilled in the art that variations in form, detail, compositions and operation may be made without departing from the spirit and scope of the invention as defined by the accompanying claims.

### LEGEND

| 10: main body | 11: receiving portion | 12: entrance |
|---|---|---|
| 20: heater | 30: far-infrared radiating member | |
| 40: foot stand | 50: insulator | 60: controller |
| F: frame | P: axle | |

What is claimed is:

1. A dry sauna machine comprises:
a main body configured to receive a partial or whole body of a user;
a heater installed on a floor surface of the main body;
a far-infrared radiating member installed on a top surface of the heater; and
a foot stand installed at a side inner surface of the main body,
wherein the far-infrared radiating member comprises a groove adapted for containing aroma oil.

2. The dry sauna machine of claim 1, wherein the heater extends up to a lower surface of the foot stand.

3. The dry sauna machine of claim 1, wherein the heater is a surface-type heating body.

4. The dry sauna machine of claim 1, wherein the groove in the far-infrared radiating member is half-circular.

5. The dry sauna machine of claim 1, wherein the far-infrared radiating member is made of one selected from the group consisting of tourmaline, red clay, rock salt, germanium, elvan, jade, charcoal, and ceramic.

6. The dry sauna machine of claim 1, further comprising an insulator provided between the floor surface of the main body and the heater.

7. The dry sauna machine of claim 1, wherein the heater is installed so as to stay away from the floor surface of the main body rotatable about an axle.

8. The dry sauna machine of claim 2, wherein the heater is installed so as to stay away from the floor surface of the main body rotatable about an axle.

9. The dry sauna machine of claim 3, wherein the heater is installed so as to stay away from the floor surface of the main body rotatable about an axle.

10. The dry sauna machine of claim 4, wherein the heater is installed so as to stay away from the floor surface of the main body rotatable about an axle.

11. The dry sauna machine of claim 5, wherein the heater is installed so as to stay away from the floor surface of the main body rotatable about an axle.

12. The dry sauna machine of claim 1, further comprising a plurality of light-emitting diodes (LEDs) disposed along one or two edges of the far-infrared radiating member and configured to illuminate the far-infrared radiating member from edges thereof.

13. The dry sauna machine of claim 12, wherein the plurality of light-emitting diodes (LEDs) are disposed in an assembling frame.
